(19) United States
(12) Patent Application Publication
(10) Pub. No.: US 2008/0054617 A1
(43) Pub. Date: Mar. 6, 2008

(54) Vehicle Having At Least One Seat For At Least One Vehicle Occupant And A Belt System

(76) Inventor: Wilfried Schwant, Meinersen (DE)

Correspondence Address: GREENBLUM & BERNSTEIN, P.L.C., 1950 ROLAND CLARKE PLACE, RESTON, VA, 20191, US

(21) Appl. No.: 11/569,747

(22) PCT Filed: May 11, 2005
(86) PCT No.: PCT/DE05/00880

§ 371 Date: Nov. 28, 2006

(30) Foreign Application Priority Data
May 29, 2004 (DE) 10 2004 026 751.0
Jun. 18, 2004 (DE) 10 2004 029 456.9

(51) Int. Cl. B60R 22/46

(52) U.S. Cl. 280/806

(57) ABSTRACT

The invention relates to a device that after the belt slack present in a belt system has been removed by a tightening system, with the aid of a compressed gas stored in a tank generates a force via a piston/cylinder system in the belt system, which force has the necessary level in the event of an accident to stop the occupant. The impingement of the piston with the compressed gas in the tank can occur through the release of the breechblock piston secured with a blocking pin or also with a projectile destroying a membrane. The compressed gas located in the container can also be brought to the necessary operating pressure by a pyrotechnical propellant charge in the event of a collision, at which pressure a rupture membrane then breaks. The maximum level of the gas pressure can be influenced by a control valve. The reduction of the gas pressure after the end of the collision can be carried out through a throttle opening.

The invention relates to a vehicle with at least one seat for at least one vehicle occupant and with a belt system with which the vehicle occupant is restrained in the seat in the event of a decelerating operation of the moving vehicle exceeding a minimum deceleration value.

Vehicles, in particular motor vehicles, are regularly used for transporting people. In the case of automobiles, 4 or 5 seats are generally located in the vehicle, each providing space for one person, thus for one vehicle occupant. When the vehicle is moving, at least one vehicle occupant, namely the driver, is thereby always in his seat.

Accelerating and decelerating operations occur while driving, which operations occur within specific customary limits and do not represent any danger to the vehicle occupant.

However, it is problematic if the vehicle collides with an obstacle and a very sharp deceleration of the vehicle as well as of the vehicle occupant thereby occurs that exceeds a minimum deceleration value. If no further measures are taken, serious injuries to the vehicle occupant can occur. For this reason for many decades belt systems have been used that are designed to restrain the vehicle occupant in his seat during such decelerating operations after a collision.

Seatbelts are intended as far as possible to protect the vehicle occupant from impact with vehicle parts in the event of a decelerating operation of this type and at the same time to limit the forces acting on the vehicle occupant from the seatbelt to a tolerable level for people.

If no such limitation of the forces acting on the vehicle occupants from the seatbelt is undertaken, the seatbelt would cause the same injuries to the vehicle occupant that would be caused by a direct collision with an obstacle by the vehicle occupant. In FR 1 180 364 B an expansion element in the seatbelt is proposed for a limitation of this type of forces acting on the vehicle occupant from the seatbelt. The use of an expansion element with a seatbelt inevitably leads to an increase of the relative distance between the vehicle colliding with an obstacle and the vehicle occupant.

The total stopping distance is composed of the deformation distance that is available to the vehicle through its deformation during this decelerating operation until it is at a standstill relative to the surface, on the one hand, and additionally of the distance that the occupant can cover relative to the vehicle until he collides with components in the interior of the vehicle.

In an emergency, this stopping distance must be sufficient to dissipate the kinetic energy contained in the vehicle occupant relative to the earth's surface at the start of the collision of the vehicle with the obstacle. If the stopping distance and the free distance are not sufficient, collision with the vehicle parts occurs and injury of the occupant by the vehicle components can then no longer be avoided either.

In order to reduce the forces in the seatbelt to the lowest possible level with the aid of an expansion element and thus to keep the stresses on the person during an accident as low as possible, it is therefore expedient to design the stopping distance to be as long as possible. Since the free spaces between the occupant and the vehicle parts, e.g., the steering wheel, are determined by ergonomic values for a person, in this area an increase in the stopping distance would be possible only by withdrawing components, which is also being attempted in practice to a certain extent.

In physical terms there is still the possibility of increasing the length of the front end without blocking the deformation distance thereby gained with additional components. However, in practice this is impossible.

Nowadays belt systems are usually equipped with an automatic belt retractor. With a belt system with an automatic belt retractor the blocking of the belt webbing in an accident is initiated by a mechanical sensor. The belt retractor mechanism is thereby blocked via a ratchet system due to a relative movement of the inertial sensor mass of the sensor relative to the vehicle. Furthermore, the occupant also moves relative to the vehicle without forces in the seatbelt holding the occupant until all belt slack between the occupant and the belt have been eliminated. Belt slack of this type is, e.g., the belt webbing wound loosely on the belt retractor or the occupant's clothing.

DE 22 23 061 A1 proposes a further improvement particularly with belt systems of this type. It uses a tensioning device for the seatbelts and in this manner shifts the increase in belt force on the vehicle occupant to a somewhat earlier time, thus improving the physical conditions.

With the combination of an expansion element and a tensioning device, such as according to DE 22 23 061 A1, the following physical sequences occur in a seatbelt in the event of a collision of the vehicle:

A sensor detects the collision of the vehicle with an obstacle. The sensor assesses the deceleration course of the vehicle according to a special algorithm so as to generate an electric impulse to activate the igniter of the tensioning device when a defined accident severity is exceeded. The igniter then ignites a pyrotechnical propellant charge, the gas of which initiates a rotary motion of the belt coiling shaft via various mechanical systems to remove the belt slack. Mechanical tightening devices with different embodiment tighten the belt webbing with the aid of a linear movement of the belt buckle, which movement is likewise initiated by a pyrotechnical propellant charge.

A force is thereby generated in the seatbelt. The force depends on the kinetic energy of the inertial masses of the tensioning device itself brought up to speed by the tensioning device and on components of the belt system. The spring rigidity of the belt webbing and the occupant and the tensioning distance produced thereby determine the level of the force.

Since the relative movement between the belt system and the vehicle occupant is equal to zero at the conclusion of the tensioning operation, the entire kinetic energy of the inertial masses moved has to be converted into potential energy during the tensioning operation, namely belt force multiplied by the deformation distance of the belt webbing and the deformation distance of the vehicle occupant.

The seatbelt is therefore tightened by the tensioning device such that the so-called belt slack of the seatbelt as well as the slack of the clothing of the vehicle occupant are removed. These are the loose items of clothing between the belt webbing and the body of the vehicle occupant that are thus compressed as well as loose, not pressing components of the belt webbing which usually intentionally exist while the vehicle is in motion so as not to unnecessarily impede the vehicle occupant while driving and not to interfere with his well-being. However, the belt webbing is briefly and sharply tightened by the tensioning device and a sensor detects that a collision of a certain severity by the vehicle with an obstacle has occurred. In physical terms the very small inertial mass of the belt webbing and the loose items of the clothing is thereby moved over a tensioning distance within a very short time through a high acceleration of the tensioning device. Compared to the inertial masses of the vehicle as a whole or of the vehicle occupant, the masses to be moved are extraordinarily small.

A relative movement between the occupant and the vehicle does not thereby occur, since the energy used for the tensioning operation of the belt webbing is not sufficient to move the relatively large mass of the vehicle occupant.

The occupant first moves relative to the vehicle through the front end deforming during the accident and the deceleration of the vehicle that starts at the same time. The occupant follows the original direction of travel, hence he moves from the seat in the direction of the front end. The belt webbing is thereby stretched further and the belt forces increase to a level that brings the occupant to a standstill relative to the earth's surface over the deformation distance still provided by the vehicle from this moment on and the free space of the occupant in the vehicle. The expandability of the belt webbing thus follows a compromise: the belt webbing should be expandable enough that the vehicle occupant is not stressed and decelerated beyond a barely justifiable value avoiding serious injury. On the other hand, its expandability should be kept low enough that during the deceleration the vehicle occupant comes to a standstill if possible before colliding with vehicle parts in the interior of the passenger compartment or that at any rate the injuries upon collision are kept as low as possible.

Despite these successfully implemented belt systems and belt tightening devices, there is still a desire for further improvements in the course of vehicle accidents, for example in collisions with an obstacle.

Attempts have been made to meet this demand through very complex cushioning devices, such as, e.g., airbags. However, these cannot meet all the demands.

Another measure to initiate the relative movement of the vehicle occupant to the vehicle as quickly as possible and in this manner to obtain more stopping distance for the occupant, would be if the deceleration of the vehicle is as high as possible from the start of the accident, therefore if the deformation area is embodied to be relatively hard. However, taking into account the consistency with other vehicles in an accident, the front deformation area should be embodied to be softer. For accidents of less severity it is also expedient to embody the front deformation area to be softer.

The measure of embodying the front area of the vehicle front end to be harder in construction in order to reduce the stresses on the occupant in the event of a severe accident, is therefore disadvantageous in other types of accident. This approach, like the extension of the front end, is therefore not practical either.

The object of the invention is therefore to embody a generic vehicle such that in the event of an accident the stresses on the vehicle occupants are further reduced.

This object is attained in that the belt system is equipped with a device that acts on the vehicle occupant continuously during at least half of the duration of the decelerating operation via the belt system with a force directed against the direction of travel, which force is sufficiently large to bring the vehicle occupant to a standstill with respect to the earth's surface on a stopping distance of the vehicle occupant provided by the vehicle relative to the earth's surface. The stopping distance of the vehicle occupant is thereby composed of the distance that can be covered by the vehicle occupant in the passenger compartment of the vehicle up to a collision with an object and of the deformation distance of the vehicle or the crumple zone.

Surprisingly, the object is attained thereby. Over a substantial part of the decelerating operation the vehicle occupant is moved by the belt system relative to the vehicle against the direction of travel. The opposite is known: the vehicle occupant moves relative to the vehicle in the direction of travel, that is, forwards. After all, in the prior art the expansion behavior of the seatbelt is first triggered by this movement forwards and this movement is thus damped as far as possible.

However, according to the invention instead a movement of the vehicle occupant is initiated in the opposite direction at the earliest possible moment. The expansion behavior of the seatbelt is therefore not yet utilized at this time. It should be noted that the entire decelerating operation is extremely short in terms of time. During this extremely short time, the vehicle occupant is not moved over large distances relative to the vehicle, but the result of this movement is that the acceleration peaks occurring in the prior art are completely relieved and neutralized.

In today's vehicles, with the buildup of the restraining forces in the belt webbing of the seatbelt of the belt system through the relative movement between the vehicle occupant and the vehicle is generated. In the embodiment according to the invention the forces necessary to stop the vehicle occupant are generated immediately. The force generated in the belt system by the additional embodiment of the vehicle is designed such that the deformation distance provided by the vehicle can be much better used physically than is possible in the prior art.

The tensioning device known, e.g., from DE 22 23 061 A1 is still useful as an additional element, since it is completely independent of the design of the vehicle according to the present invention and the removal of belt slack is still expedient with a vehicle according to the invention and supports the effect.

However, the difference between the design according to the invention and a tensioning device according to DE 22 23 061 A1 is considerable in technical and physical terms. In the known tensioning device only the masses of the tensioning device and the belt webbing are accelerated once for a very short period in order to produce an optimal application of the belt. The kinetic energy of the masses thereby generates only a small preloading in the belt webbing. However, with the embodiment according to the invention, a belt force is generated that decelerates the large mass of the vehicle occupant, and at that over the entire deceleration period, or at least over a substantial part thereof comprising more than half.

In practice, controlled deceleration and thus influencing the movement is preferably carried out over the entire period of the decelerating operation. Naturally, considerable forces must thereby be applied in the seatbelt, which forces can be controlled and modulated accordingly to optimize the operation. The expandability of an expansion element is not utilized until a relatively late moment in the decelerating operation.

It is desirable for the corresponding effects and the control to start as soon as possible. If the development therefore leads to sensors that can detect a collision of sufficient severity at increasingly earlier stages or that can even predict it, this can be utilized accordingly for the design according to the invention in order to optimize the overall deceleration of the vehicle occupant such that the stress is further reduced.

The details of this physical effect will be discussed in more detail below.

It becomes possible with the invention to utilize the entire deformation distance of the front end of the vehicle as well as additionally the distance available in the interior. After the detection of the accident or collision and thus of the decelerating operation exceeding the minimum deceleration value, the belt system is kept at a force level that is suitable for restraining the occupant at the most constant possible level. After a tensioning operation preferably carried out, instead of waiting for a relative movement between vehicle and vehicle occupant, this force level is already reached by supplying additional energy after the tensioning operation.

The belt system acts on the vehicle occupant preferably with a force of a size that the vehicle occupant is moved against the direction of travel relative to the vehicle without a decelerating operation, thus a force that is larger than the force that is required to equalize the belt slack. The size of the force is thereby such that the belt does not cause any harm to the vehicle occupant, therefore remains below a predetermined maximum stress or maximum acceleration.

The device can also control the force applied via the belt system such that the stress on the vehicle occupant due to the decelerating operation remains essentially constant over the stopping distance of the vehicle occupant in order to move the vehicle occupant relative to the vehicle against the direction of travel.

The invention that acts on the vehicle occupant continuously during at least half of the duration of the decelerating operation via the belt system with a force, preferably has a piston in a cylinder that applies a force in the belt system via a piston rod.

Further preferred features are reflected in the subordinate claims.

Some exemplary embodiments of the invention as well as the advantages and the course of the decelerating operation of the vehicle occupant possible with the invention are explained below based on the drawing. They show:

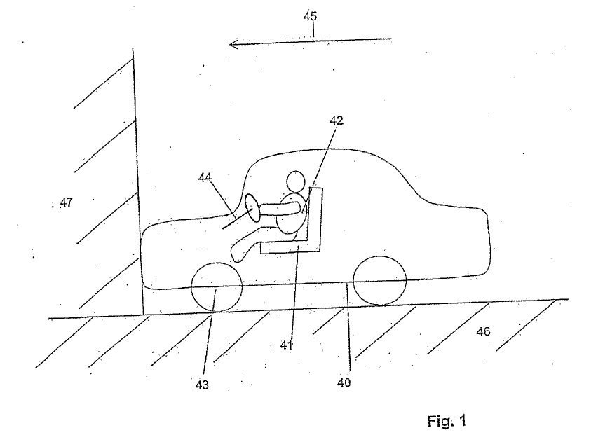

FIG. 1 A diagrammatic representation of a vehicle;

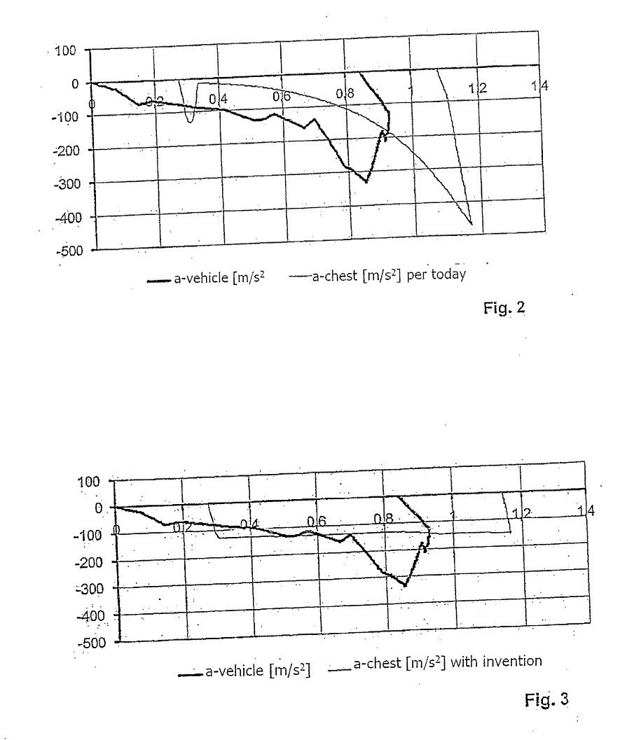

FIG. 2 A diagram of the acceleration over the stopping distance relative to the earth's surface according to today's prior art;

FIG. 3 A diagram of the acceleration over the stopping distance relative to the earth's surface according to a first embodiment of the invention;

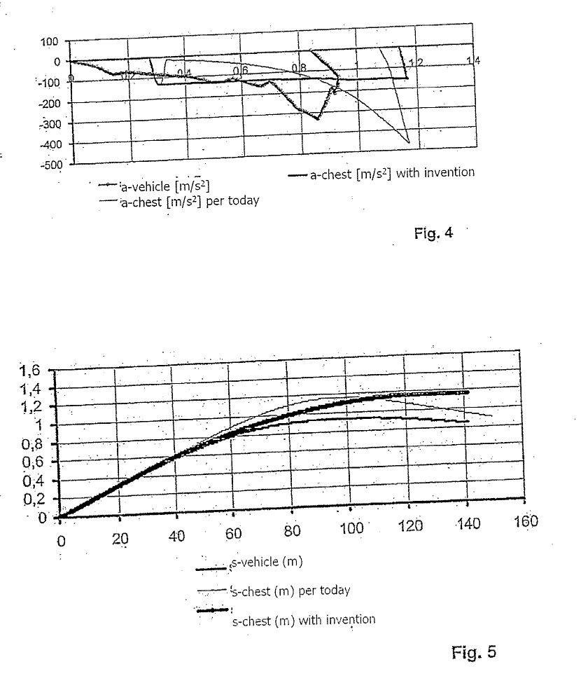

FIG. 4 A diagram that makes it possible to compare the curves from FIGS. 2 and 3;

FIG. 5 A diagram showing the stopping distance plotted against the time under conditions as shown in FIG. 4;

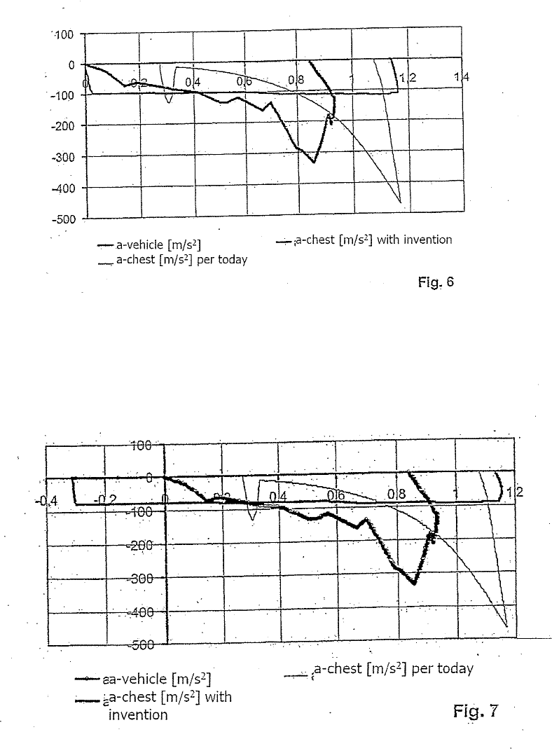

FIG. 6 A diagram, similar to the representation in FIG. 4, showing curves in another embodiment of the invention;

FIG. 7 A diagram, similar to the representation in FIG. 6, showing curves in another embodiment of the invention;

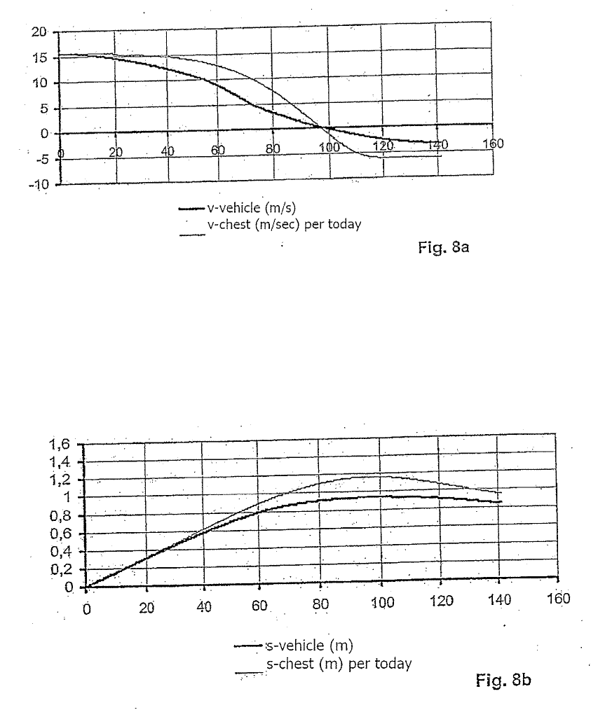

FIG. 8 Two further diagrams showing the speed and the stopping distance plotted over time according to the prior art;

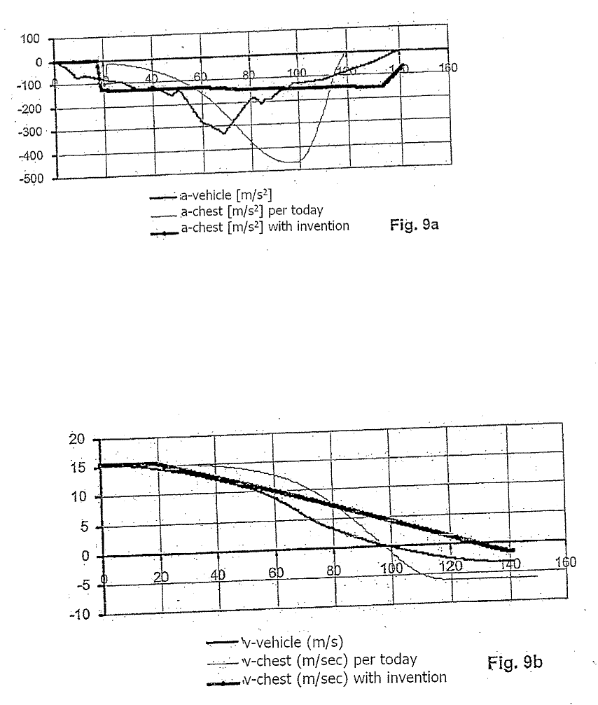

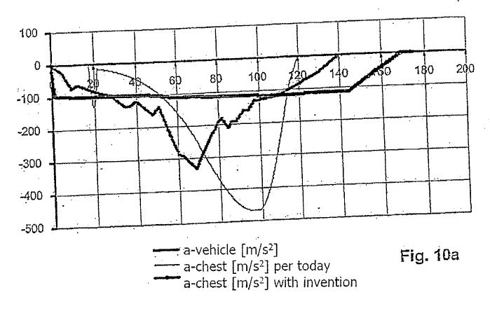

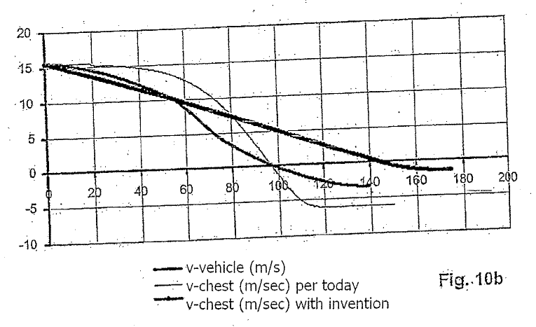

FIG. 9 Two further diagrams showing the acceleration and the speed plotted over time with a behavior according to the invention;

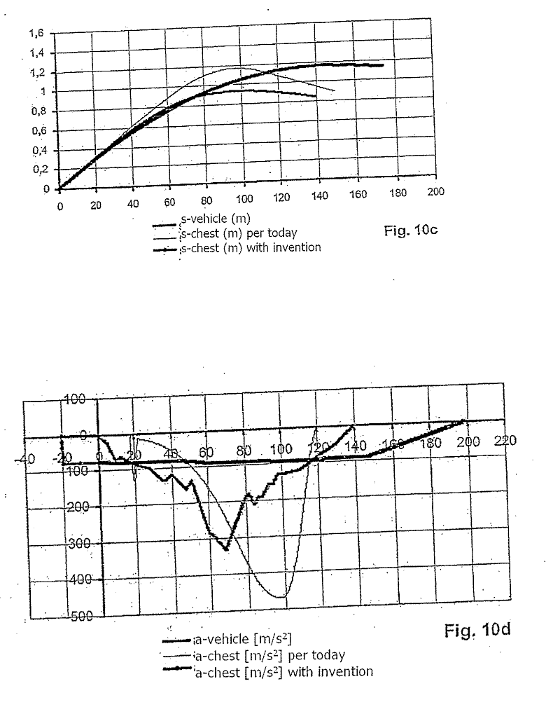

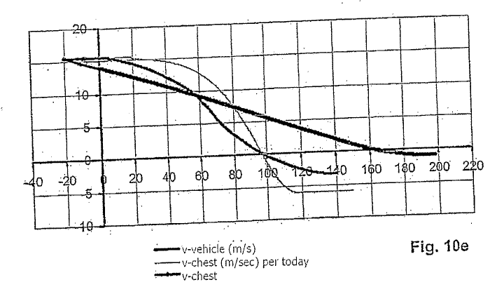

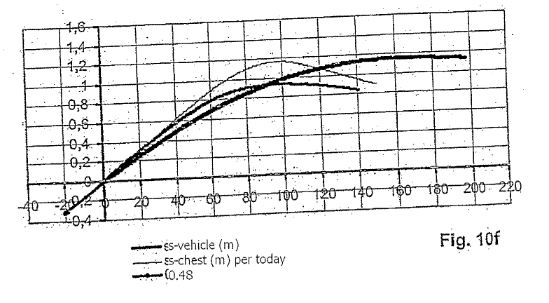

FIG. 10 Six further diagrams showing the acceleration, the speed and the stopping distance respectively plotted over time with two alternative embodiments of the invention;

FIG. 11 An overview sketch with an exemplary embodiment of the invention in diagrammatic form;

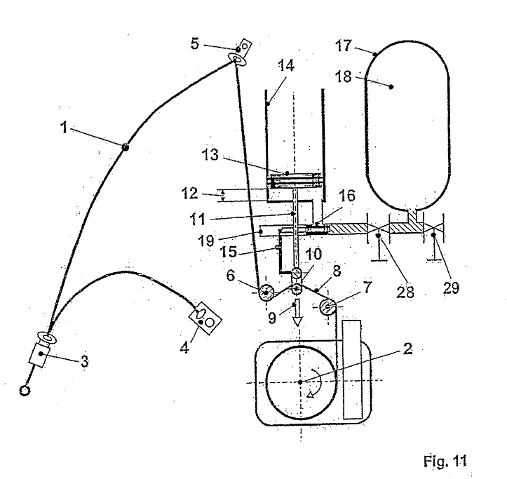

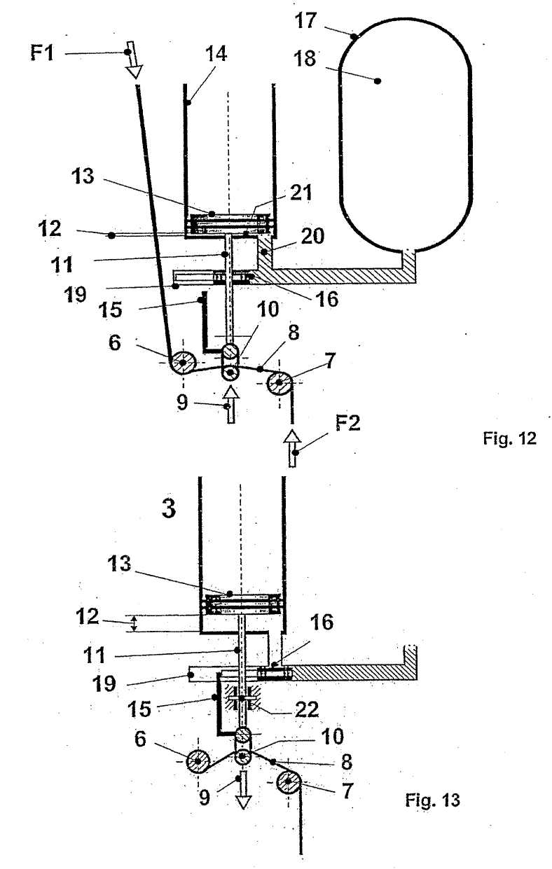

FIG. 12 A representation as an extract of the behavior of a piston rod from the exemplary embodiment in FIG. 11;

FIG. 13 A section of an alternative embodiment;

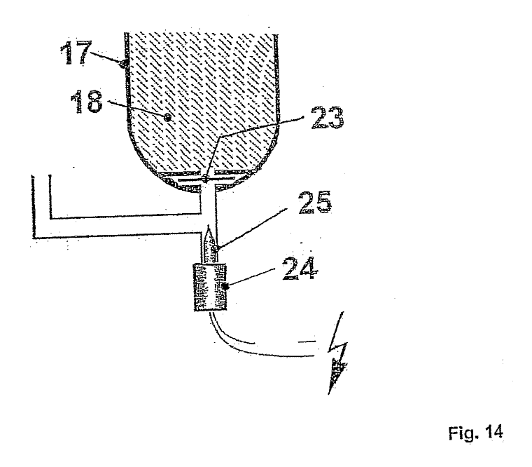

FIG. 14 A section of a different alternative embodiment;

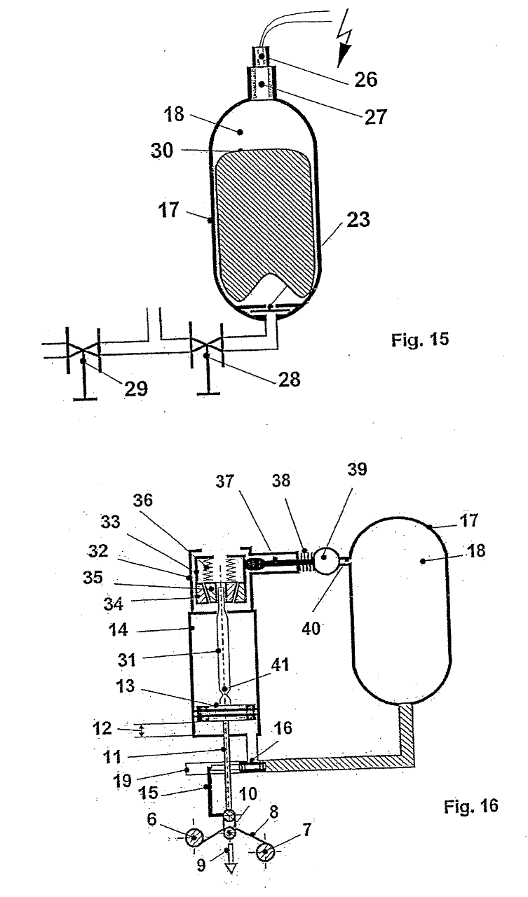

FIG. 15 A section in still another alternative embodiment;

FIG. 16 A schematic sketch for another embodiment with a second opening of a pressure tank;

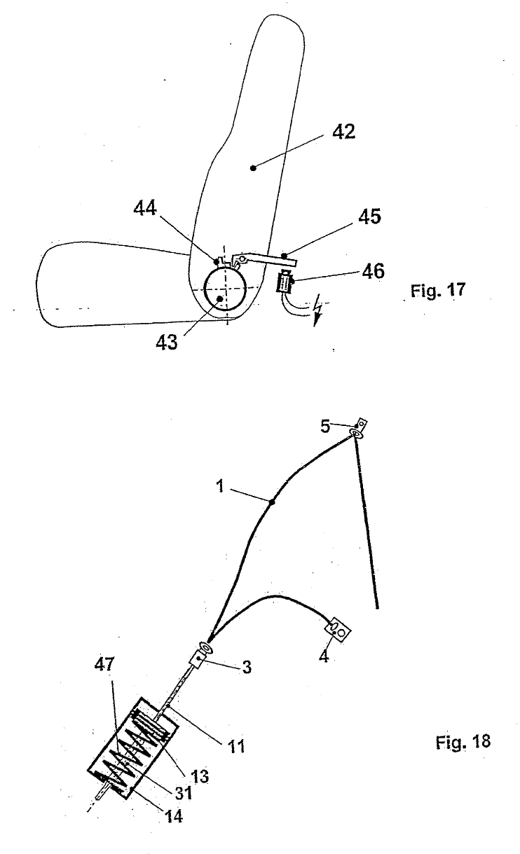

FIG. 17 An overview representation of an additional equipment of the seat back of the vehicle;

FIG. 18 A sectional sketch for another additional device;

FIG. 19 A cross-sectional representation through a part of a power cylinder;

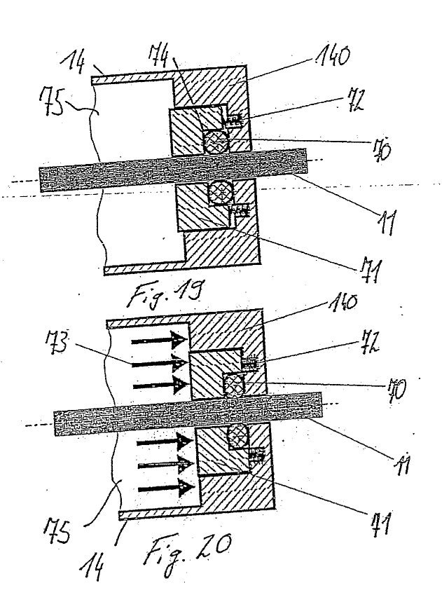

FIG. 20 A representation according to FIG. 19 with increased internal pressure;

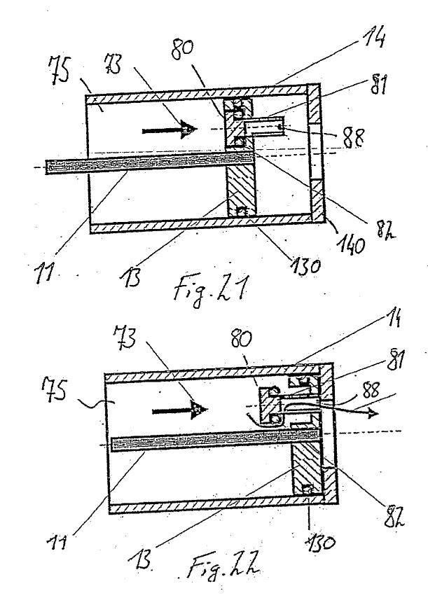

FIG. 21 A cross-sectional representation of a power cylinder with pressure application; and

FIG. 22 A power cylinder according to FIG. 21 with a piston in final position.

FIG. 1 shows purely diagrammatically a vehicle 60. A seat 61 is located in the vehicle 60 and on the seat a vehicle occupant 62.

The vehicle moves on wheels 63, the vehicle occupant 62 steers the vehicle 60 with a steering wheel 64 indicated diagrammatically. The vehicle 60 moves in the direction of travel 65 relative to the earth's surface 66.

It is indicated that the vehicle occupant 62 drives into an obstacle 67 with the vehicle 60. The decelerating operation starts at the moment of impact. Any prior braking operations are thereby omitted.

FIG. 2 shows the course of deceleration of a vehicle 60 after a collision over the deformation distance relative to the earth's surface. The distance is shown in meters on the right, at the top is the acceleration in m/s². Since the vehicle 60 as well as the vehicle occupant 62 are decelerated, the acceleration value is accordingly negative. In an examination of the representation, the gravitational acceleration (g) of approx. 9.81 m/s² should be taken as a comparative scale. A deceleration of 500 m/s² would therefore be a deceleration of somewhat more than 50 g.

Two curves are plotted on the graph, both of which start at the respectively present location “0 m” at the moment of the collision of the vehicle 60. The thick curve shows the behavior of the vehicle 60 respectively from a point of the vehicle 60 approximately in the middle of the vehicle. The thin solid line shows the behavior of the chest of a vehicle occupant 62. A behavior is shown with a vehicle 60 according to the current prior art equipped with a belt system, a tensioning device and expansion elements in the belt webbing. In the test the impact speed of the vehicle 60 with the obstacle 67 was approx. 64 km/h. The obstacle 67 was thereby a deformable barrier generally used nowadays in Europe. There was an overlap of 50%, not shown in FIG. 1, thereby between the front of the vehicle and the barrier during the collision of the vehicle 60 into the barrier.

FIG. 2 shows that the vehicle comes to a standstill relative to the earth's surface after approx. 90 cm and then due to the elasticities in the body frame moves somewhat in the opposite direction. The vehicle occupant has a stopping distance relative to the earth's surface that is approx. 30 cm longer through the utilization of the interior.

In this collision the sensor system detected the collision approx. 18 milliseconds after the start of the first contact of the vehicle 60 with the obstacle 67 and activated the pyrotechnical tightening system. At this moment the center point of the vehicle and almost synchronously thereto the vehicle occupant 62 with it had moved approx. 25 cm in the original direction of travel 65 (in this case to the right). After the kinetic energy of the tightening system was exhausted by the preloading in the belt system, the deceleration then increases depending on the relative movement of the occupant 62 to the vehicle 60 and the forces thus building up in the belt system. It is furthermore discernible that the deceleration of the chest of the vehicle occupant 62 is distinctly greater than the deceleration of the vehicle 60.

It is also discernible from the thick solid line that, as is known to one skilled in the art, the “softer components” of the vehicle 60 are deformed first so that the deceleration of the vehicle 60 increases respectively in several steps whenever “harder” vehicle parts are deformed. Only in the further course are more dangerous values of more than 200 m/s² reached. However, the deceleration of the vehicle remains ultimately restricted to approx. 320 m/s².

The deceleration of the vehicle occupant 62 increases regularly and continuously due to the expansion elements in the belt system and towards the end of the deceleration reaches very dangerous and probably fatal values. It should be clear that this relatively slow buildup would not occur without a seatbelt, that instead due to the complete lack of a deformation area in his personal case, the vehicle occupant 62 would then have to reckon with a very much greater deceleration upon his collision with the vehicle parts which far exceeds the −500 m/s² in the drawing.

With the use of the occupant protection systems known today, such as seatbelt with pyrotechnical tightener, expansion elements and airbag, the deformation distance provided by the vehicle front end is effectively utilized only 25% to 35% for stopping the occupant from the travel speed at the start of the collision to zero speed to the earth's surface.

This results in the greater deceleration of the occupant 62 with respect to the vehicle 60 necessary towards the end of the operation.

Now another sequence is made possible according to the invention which gives the vehicle occupant 62 a distinctly greater chance of survival, or reduces his risk of injury given other basic conditions.

The effect possible with the invention is discernible from FIG. 3. Here again with similar graphics to FIG. 2 the acceleration of the vehicle 60 and the chest of the occupant 62 are shown in m/s² over the distance relative to the earth's surface in m. The vehicle 60 naturally behaves exactly as in FIG. 2, since the vehicle deceleration is not affected by the invention. However, the characteristic of the course of acceleration of the chest is distinctly different from the course in FIG. 2.

A sensor system with an ignition 18 milliseconds after the collision has been assumed here.

FIG. 4 shows the chest accelerations both with and without use of the invention over the stopping distance of the occupant 62 relative to the earth's surface, thus making a direct comparison possible. To this end the curves from FIGS. 2 and 3 are superimposed. The curve for the deceleration movement of the vehicle 60 is identical, the curve showing the deceleration of the chest of the occupant 62 is drawn somewhat thicker for the behavior according to the invention than for the behavior according to the prior art for reasons of clarity.

If the chest accelerations with the use of a 3-point seatbelt with belt tightener to remove the belt slack and an expansion element, as used today and shown in FIG. 2, is compared with otherwise identical basic conditions with the chest acceleration with additional use of the invention, in a collision at approx. 64 km/h, a detection of the collision by the sensor system approx. 18 milliseconds after the first contact of the vehicle with the obstacle, with the same deformation distance of the front end of the vehicle 60 and the same utilization of the free space in the interior, the maximum of the chest acceleration is reduced by over 60%. The deformation of the chest and the stress on neck and head are thus also correspondingly lower.

Through the invention a larger force is exerted on the vehicle occupant 62 at a much earlier stage than before. As the sensor system detects that a collision has occurred with possibly serious consequences, force is exerted on the vehicle occupant 62. He is therefore stressed more than before. This stress is so high that it seems barely tolerable without physical harm. A comparative value by way of example could be taken to be a full-body impact by a soccer ball kicked with force. This is certainly unpleasant and painful for the vehicle occupant 62, but can be accepted in view of the consequences that might otherwise have occurred up until now.

This stress is now maintained at a largely constant level. FIG. 5 shows on the right the time in milliseconds (msec) that has elapsed since the collision with the obstacle 67. It is clear that the entire operation takes a fraction of a second. The stopping distance is shown in meters (m) at the top. The curves correspond to those from FIG. 4.

As FIG. 5 shows, the largely constant force means that the vehicle occupant 62 actually moves relative to the vehicle 60 against the direction of travel, thus he moves for a relatively long period in the direction of the vehicle rear end. The thick solid curve reflecting the behavior according to the invention namely runs below the curve reflecting the vehicle behavior. The vehicle 60 is therefore “faster” than the occupant 62, so that he is pressed against the seat back.

However, the distance covered is minimal, what is interesting and important for the risk of injury are the acceleration values that apply thereby. However, the direction of movement is a good indication of the forces applied which after all are fundamental for precisely these acceleration or deceleration values.

However, in view of the deceleration values of the vehicle 60 constantly increasing during the deceleration period, these ultimately exceed the deceleration of the vehicle occupant 62 (cf. FIG. 4), which however is no longer critical for him, at least in the case shown in the example. Only when a still higher starting speed no longer permits any tolerable deceleration values, is the invention no longer helpful either.

Another improvement of the invention even for cases of this type is possible with the use of sensor systems that can already detect the severity of the accident upon impact. The stress as shown in FIG. 6 is then further reduced. Similar to the representation in FIG. 4, FIG. 6 shows the acceleration in m/s² plotted over the stopping distance in meters relative to the earth's surface. Again, three curves have been plotted. The behavior of the vehicle 60 and of the vehicle occupant 62 according to the prior art are unchanged, the solid curve of medium thickness shows the behavior when the sensor system already detects the accident upon impact and an ignition would therefore occur after 0 milliseconds, thus without delay.

Still further reductions of the stress on the occupant are possible if sensor systems that can detect the severity of the accident even before impact are used.

The representation of the accelerations in m/s² plotted over the relative distance to the earth's surface in meters in FIG. 7 with conditions otherwise unchanged with respect to FIG. 6 shows the outcome if the severity of the accident was already detected by the sensor system approx. 30 cm or 20 milliseconds before the collision of the vehicle 60 with an obstacle 67 and an electrical signal is available to activate the occupant protection system.

Since in this case the acceleration of the chest of the vehicle occupant 62 already starts before the acceleration or deceleration of the vehicle 60, a movement of the chest of the vehicle occupant 62 against the direction of travel 65 of the vehicle 60 occurs now. In this case, however, the distance required for this movement can therefore be somewhat larger and no longer absorbable by the elasticity of the seat 61. In order not to impede the necessary movement of the chest of the vehicle occupant 62, with relative movements of the chest to the seat 61 in which the seat cushion generates through compression counterforces that are too high, it is necessary to render possible a free travel space for the seat back. A corresponding technical solution is provided below.

In order to prevent stress on other vehicle occupants sitting behind the seat 61, the free travel space of the seat back should be limited accordingly.

FIG. 8 shows two diagrams that reflect the behavior of the speed and the stopping distance in the prior art. In this case both representations are plotted over time and not over the distance. It is clear from both sketches that the speed of the vehicle occupant remains unchanged at first, while the vehicle is already decelerated. The reduction of the speed of the vehicle occupant does not occur until much later. Since the vehicle occupant naturally also needs to reach 0 speed at a specific time, the reduction of the speed constantly increases towards the end of the decelerating operation and has then lead to the deceleration peaks shown in FIGS. 2 and 4.

FIG. 9 shows the acceleration and the speed respectively in m/s₂ again plotted over time, in this case again three curves that correspond to the representation of FIG. 5. Again, it is clear that the deceleration of the vehicle occupant in the prior art would have an extreme value in the order of approx. 450 m/s². However, the deceleration of the vehicle occupant according to the invention does not exceed the value of approx. 150 m/s².

It is also clear with the speed that the solid line that shows the behavior of the vehicle occupant according to the invention drops much more evenly. This drop starts much earlier than according to the prior art and can then occur much more slowly, since more time is also available.

FIG. 10 shows six diagrams reflecting the acceleration, the speed and the stopping distance for variants in which an ignition already occurs at 0 s, thus virtually upon impact, instead of 18 ms after impact, or finally in the lower drawing at 20 ms or approx. 30 cm before impact, such as through sensor systems that can detect and interpret the collision optically or in another manner even before the actual event.

The curves show that the behavior already improves to an even greater extent than in FIG. 9 or FIG. 4 and the stresses on the vehicle occupant are reduced accordingly but that substantially nothing else changes about this behavior. The possible effect occurring is that the maximum deceleration can be further reduced, which alternatively can also mean of course that an even greater impact with an even greater starting speed through such measures can lead to an outcome in which the vehicle occupant can survive.

A practical embodiment with which the invention can be realized is shown first in overview in FIG. 11. The belt system 1, such as, e.g., the 3-point belt system 1 shown in FIG. 3, comprising a belt retractor 2 with an integrated tightening system that operates on a pyrotechnical, electrical, pneumatic or hydraulic basis, for removing belt slack and possibly an expansion element to limit the belt forces, a belt buckle 3, an end fitting 4 and a deflector 5. It is supplemented by, e.g., two deflectors 6, 7 that are positioned such that with a tightening of the belt webbing 8 via a deflector 10 attached to a piston rod 11, a force component 9 moves the piston 13 in the cylinder 14 over the distance 12.

The movement of the piston rod 11 in the direction 9 is initiated by the tensioning operation of the tightening system 2.

With the movement of the piston rod 11, as shown in FIG. 12, a locking pin 15 attached to the piston rod 11, which locking pin serves as a block for a breechblock piston 16, is retracted. A compressed gas 18 is located in a pressure tank 17. This gas 18 then pushes the breechblock piston 16 into a receiver chamber 19. The compressed gas 18 now flows via a connecting line 20 into a cylinder area 21 and thus generates a belt force F1, F2 via the piston 13, the piston rod 11 and the deflector 10.

The level of the belt force F1, F2 is determined by the pressure of the compressed gas 18 and the surface of the piston 13. The volume ratio of the pressure tank 17 to the volume in the area 21 of the cylinder 14 should be as large as possible with a largest used stroke distance 12, so that a belt force F1, F2 as constant as possible is generated over the entire stroke of the piston 13.

In order to prevent with a normal braking of the vehicle with which the belt retractor 2 is blocked and a belt force F1, F2 is generated through the relative movement of the occupant to the vehicle, that the breechblock piston 16 is thereby already released via the locking pin 15, the piston pin 11, and the deflector 10, the piston pin 11, as shown in FIG. 13, can be secured by a blocking pin 22.

The strength of the blocking pin 22 is designed such that the belt forces F1, F2 generated by braking are not sufficient to shear off the blocking pin 22. Only the higher belt forces F1, F2 that are generated by the tightening device 2 to remove the belt slack, are designed to destroy the blocking pin 22.

Another possibility is to remove the locking pin 15 by the tightening device for removing the belt slack with the aid of a mechanical connection, e.g., via a centrifugal clutch on the tightening system 2 with a cable control.

It is achieved with this mechanical clutch that the correspondingly high deceleration of the occupant for utilizing the deformation distance of the vehicle 60, which deceleration generates the belt forces F1, F2 through the system described, occurs at the correct intended moment.

The impingement of the piston 13 with the compressed gas 18 located in the tank 17 can also occur as shown in FIG. 14. A projectile 25 is driven by a pressure cylinder 24 that punctures a closing membrane 23 of the pressure tank 17, thereby opening it. The ignition of the pressure cylinder 24 thereby occurs in this embodiment through the sensor system of the belt tightener for removing the belt slack and is coordinated in terms of time such that the (closing) membrane 23 of the pressure tank 17 is not ignited until after the removal of the belt slack. The time for igniting the pressure cylinder 24 should be chosen such that the tightening operation for removing the belt slack has been largely completed.

In order not to have to ensure the necessary very high operating pressure over a long period, there is the possibility of generating the necessary operating pressure of the gas 18 in the tank 17 only upon impact. FIG. 15 shows an embodiment for this. The rupture of the (rupturing) membrane 23 used is achieved as follows. The pressure of the gas 18 in the pressure tank 17 is below the pressure necessary for the protective effect. The (rupturing) membrane 23 is thereby sized such that it withstands a low gas pressure but breaks with the pressure necessary for the protective effect. An ignition 26 is ignited with a collision detected by the sensor system. The ignition 26 then starts a pyrotechnical propellant charge 27. The combustion gases thereof increase the pressure in the tank 17 to the operating pressure necessary for the protective effect. When the operating pressure is reached, the (rupturing) membrane 23 breaks and thus releases the connection 20 for acting on the piston 13 with gas 18 under pressure.

In order to minimize the pressure losses during the accident or the deceleration phase after the collision by cooling the combustion gases of the propellant charge 27, the pressure tank 17 can be supplemented with the addition of a porous heat-absorbing mass 30. The gases generated by the propellant charge 27 are thereby immediately brought to a lower temperature. The adiabatic heat exchange of the compressed gas is thus minimized during the collision.

However, in order to counteract the cooling occurring during the expansion of the compressed gas and the pressure drop associated therewith, the pressure 18 generated by the propellant charge in the pressure tank 17 can also be brought to a higher level than the operating pressure necessary for the restraining effect.

With the use of sensor systems that can detect the severity of the accident and/or the mass of the vehicle occupant 62, there is the possibility of varying the gas pressure 18 accordingly with an adjustable valve 28.

The belt force F1 is influenced at the deflector point 6 and the deflector fitting 5 by friction between the belt webbing 8 and the surfaces of the deflector points. The belt force in the area of the chest of the occupant 62 is therefore reduced by these friction forces upon the application of the force generated by the piston 13 via the piston rod 11 and the deflector 10.

If the vehicle deceleration generates a relative movement of the occupant to the vehicle, through which belt forces are produced that are larger than the belt forces on the occupant generated by the invention, the piston 13 is moved via the deflector 10 and the piston rod 11 in the direction 9, thus downwards in FIG. 11.

The forces thereby produced in the belt webbing in the area of the chest of the occupant 62 are influenced by the change of the direction of movement. The force generated by the piston 13 via the piston rod 11 and the deflector 10 is increased by the friction forces of the deflectors.

The higher deceleration of the occupant associated therewith can be counteracted, e.g., as shown in FIG. 16.

An extension 31 is located on the piston 13 on the pressureless side, which extension is longer than the cylinder 14. Assigned to the cylinder 14 is a 35, several springs 36 and an intermediate housing 38, furthermore a tappet 37, a closure body 39 and a pressure-limiting spring 38.

The extension 31 is embodied geometrically in the movement area 12 of the piston 13 such that there is no contact with the freerunning.

If, however, the piston 13 overtravels the movement area 12 against the direction 9, a form closure is produced between the extension 31 and the inner clamping jaws 35. The springs 36 ensure that the inner clamping jaws 35 remain in their position between the outer clamping jaws 34. Through the lower friction forces between the extension 31 and the inner clamping jaws 35 there is no appreciable impact on the forces of the piston 13.

The pressure tank 17 has a vent hole 40. This is closed by a closure body 39 that is supported by the tappet 37 against the intermediate housing 33.

If the piston 13 undergoes a reversal of the movement direction in direction 9 due to high vehicle decelerations, the inner clamping jaws 35 clamp on the outer clamping jaws 34 and the intermediate housing 33 is moved in the direction 9.

The tappet 37 thus no longer has any counter-bearing and the biased spring 38 determines the level of the pressure of the gas 18 in the tank 17.

The level of the pressure of the gas 18 should thereby be limited to the level that a force generates in the belt webbing via the piston 13, the piston rod 11 and the deflector 10, which force, increased by the friction forces of the deflectors of the belt webbing, produces the desired deceleration for the occupant.

In order to minimize the size of the freerunning, a predetermined breaking point 41 can be arranged in the extension 31. This should be sized such that the extension 31 tears with forces that are larger than those necessary to move the intermediate housing 33.

It is achieved with this measure that the forces acting on the occupant are at the same level irrespective of the movement direction.

With the use of sensor systems that can detect the severity of an accident before collision with an obstacle or with the use of sensor systems that can already detect the severity of an accident with initially very low decelerations of the vehicle, through the invention a possibly larger relative movement of the occupant to the vehicle 60 occurs against the direction of travel 65.

In order that the relative movement of the occupant in the reverse direction to the vehicle is not impeded by the seat back 42 of the seat 61, it is expedient, as shown in FIG. 17, to design a rotating fitting 43 of the seat back 42 to be freely moveable in a range of rotation limited with an end fitting 44. The release of the rotating fitting 43 can thereby occur through a lever 45. The unlocking of the lever 45 can occur, e.g., through a magnet 46 that is acted on with electric current by the sensor system that selects the collision.

The invention can be arranged at any point in the belt system. For geometric reasons the arrangement of the invention in the area of the belt retractor 2 or in combination with the belt buckle 3 lends itself best in the vehicle.

Since the pressure of the compressed gas 18 is present in the system after the activation of the invention and after the end of the collision, a ventilation can occur with the aid of a throttle opening 29.

With the use of the invention together with a belt tightener to remove the belt slack and an expansion element, the stress on the occupant is determined only by the distance provided by the vehicle 60 and available in the interior of the vehicle for the free movement of the occupant 62 and the force level of the entire protection system adjusted in this manner.

The relative movement of the occupant 62 to the vehicle 60, which in the prior art in the belt system alone can cause the buildup of forces to restrain the occupant 62, is no longer imperatively used in connection with the invention. The characteristic of the acceleration course of the front end deforming during a collision, which characteristic is determined by the body frame structure of the front end, with the use of the invention in connection with a belt tightener for removing the belt slack and an expansion element, thus has only a less relevant physical impact, or even optionally none at all, on the protective effect than can be achieved for the occupant.

The vehicle front end structure can thus be designed according to other requirements with some embodiments of the invention. In order to provide a high protective effect for the occupant 62 in the event of an accident, it is important when using the invention to ensure the free travel space in the interior of the vehicle 60. To this end it is expedient to focus on more stable interior vehicle compartments in the further development of vehicles.

Finally, FIG. 18 shows a possibility with one embodiment of the invention for pushing the piston rod 11 behind the belt buckle on the tunnel back into its starting position after the accident, thus the conclusion of the decelerating operation. This occurs mechanically by a spring 47 after the relief of the pressure.

FIG. 19 shows in a sectional representation a part of a power cylinder 14 with a piston rod 11 guided therein, at the one end of which cylinder the pressure piston 13, not shown, is located. The piston 13, the cylinder wall 14 and the cylinder end surface 140 form a pressure chamber 75 that can be filled with a gas or compressed air when the belt system is to be acted on with a force against the direction of travel. With a pressureless power cylinder, as shown in FIG. 19, the freest possible movability of the piston 13 and the piston rod 11 is to be ensured. To this end it is expedient for the piston rod 11 to be able to move as freely as possible through the cylinder end surface 140. To this end a bore is provided in the cylinder end surface 140 with a certain oversize with respect to the diameter of the piston rod 11.

A seal 70 is arranged around the piston rod 11, which seal rests against the piston rod 11 relatively loosely and causes hardly any friction, so that the piston rod 11 can be displaced easily. The seal 70 rests on the one hand against the cylinder end surface 140, on the other hand it is enclosed on two sides by a deformation element 71 that has a groove 74 that is open in the direction of the piston rod 11 and of the cylinder end surface 140 and provides a mating surface in the axial direction of the piston rod 11 with respect to the pressure chamber 70 and in the radial direction. The groove 74 holds the seal 70 in place whereby the width of the groove seen in the axial direction is smaller than the diameter of the seal 70.

The deformation element 71 is mounted elastically via springs 72, whereby the spring forces of the springs 72 act in the direction of the pressure chamber 75. With an increased gas pressure 73 within the pressure chamber 75, as shown in FIG. 20, the deformation element 71 is pressed in the direction of the cylinder end surface 140 against the spring force of the springs 72, until either the springs 72 are at block length or the deformation element 71 bears against the cylinder end wall 140. Due to the smaller axial extension of the groove 74 relative to the diameter of the seal 70, the seal 70 is compressed, is displaced in the direction of the piston rod 11 and has the effect of intensifying the seal. Moreover, the perimeter seal 70 is pressed more around the passage opening in the cylinder end surface 140 in the axial direction, thus increasing the sealing effect in this respect.

It is likewise provided that an oblique mating surface is embodied instead of the L-shaped embodiment of the groove 74 in order to provide a force component that acts in the direction of the piston rod 11. To this end it is provided that this oblique mating surface forms an acute angle to the longitudinal extension of the piston rod 11, whereby the diameter of the then conical form of the oblique mating surface is enlarged in the direction of the cylinder end surface 140. Alternatively, a chamfer in which the seal 70 is inserted can also be embodied instead of a groove 74.

Through this type of embodiment of the power cylinder 14 it is possible to ensure a very high sealing effect and seal tightness of the pressure chamber 75 so that relatively high forces, even with a force component acting against the gas pressure 73 through the piston rod the belt system can be acted on with a force directed against the direction of travel for a sufficient length of time.

The principle of the deformation element in connection with a seal can also be used for a sealing of the piston.

In another variant of the invention according to FIG. 21 it is provided that an opening 88 is embodied in the piston 13 that is guided on a piston rod 11, which opening is closed by a closure 80. If compressed air is now inserted into the pressure chamber 75, and if a force acts in the direction of the arrow through the gas pressure 73, the piston 13 is moved in the direction of the cylinder end wall 140. The piston 13 is sealed with a piston ring 130 with respect to the cylinder wall 14, the closure 80 is sealed with a seal 82 with respect to the passage 88. The closure 80 is supported in the piston 13 in a gas-tight manner. A projection 81 is embodied on the closure 80 extending beyond the piston 13 in the direction of movement, which projection can be embodied as a pipe with a radial bore. A collar can be embodied on the cylinder end of the projection 81, the diameter of which collar is greater than the diameter of the passage 88, so that the closure 80 cannot be detached from the piston 13. Other stop forms are likewise possible.

If compressed air or another gas is now inserted into the pressure chamber 75, the gas pressure 73 pushes the piston 13 in the direction of the cylinder end wall 140. If no force directed against the displacement direction, for example through an occupant moving relative to the vehicle seat, the projection 81 strikes the cylinder end wall 140 and displaces the closure 80 supported in a displaceable manner relative to the piston 13 so that the radial bore inside the projection 81 is released when the piston 13 moves further in the direction of the cylinder end wall. The compressed air is then guided outwards through the radial bore and the pipe interior of the projection 81, as indicated by the arrow. A valve of this type is necessary if compressed air is inserted into the power cylinder 14 in a deployed system so that the piston rod 11 and thus the belt system 1 is tensioned. If the counterforce is missing through the vehicle occupant supported in the belt system, the gas pressure 73 must be released from the pressure chamber 75. This is carried out through the mechanism described above.

Alternatively thereto, a release of pressure inside the pressure chamber 75 can be effected via a port control if a bore or a slot is inserted in the cylinder wall 14 at a predetermined point, which bore is arranged such that it at or shortly before the end stop of the piston 13 on the cylinder wall 140 this opening is released so that the pressure chamber 75 is connected to the outside surroundings and the excess pressure can escape.

### LIST OF REFERENCE NUMBERS

1 Belt system, e.g., 3-point belt system
2 Belt on roller
3 Belt buckle
4 End fitting
5 Deflector
6 Deflector
7 Deflector
8 Belt webbing
9 Force component
10 Deflector
11 Piston rod
12 Distance
13 Piston
14 Cylinder
15 Locking pin
16 Breechblock piston
17 Pressure tank
18 Gas
19 Absorber piston
20 Connecting line
21 Cylinder area
22 Blocking pin
24 Pressure cylinder
25 Projectile
26 Igniter
27 Propellant charge
30 Heat-absorbing mass
31 Extension
32 Receptacle housing
33 Intermediate housing
34 Clamping jaw
35 Clamping jaw
36 Spring
37 Tappet
38 Pressure-limiting spring
39 Closure body
40 Vent opening
41 Predetermined breaking point
42 Seat back
43 Rotating fitting
44 Stop
45 Lever
46 Magnet
47 Spring
60 Vehicle
61 Seat
62 Vehicle occupant
63 Wheels
64 Steering wheel
65 Direction of travel
66 Earth's surface
67 Obstacle
70 Seal
72 Deformation element
72 Spring
73 Gas pressure
74 Groove
75 Pressure chamber
80 Closure
81 Projection
82 Seal
88 Passage
130 Piston ring
140 Cylinder end surface

1. A vehicle with at least one seat for at least one vehicle occupant Rand with a belt system with which the vehicle occupant is restrained in the seat in the an event of a decelerating operation of the vehicle exceeding a minimum deceleration value, the belt system being equipped with a device that acts on the vehicle occupant continuously during at least half of a duration of the decelerating operation via the belt system with a force directed against the direction of travel the force being sufficiently large to bring the vehicle occupant (to standstill with respect to a surface on a stopping distance of the vehicle occupant provided by the vehicle relative to the surface.

2. The vehicle according to claim 1, wherein the belt system acts on the vehicle occupant with a force of a size such that without decelerating operation the vehicle occupant is moved relative to the vehicle against the direction of travel.

3. The vehicle according to claim 2, wherein the device controls the force applied via the belt system such that stress on the vehicle occupant due to the decelerating operation remains essentially constant over the stopping distance of the vehicle occupant.

4. The vehicle according to claim 1, wherein the device that acts on the vehicle occupant continuously during at least half of the duration of the decelerating operation via the belt system with a force directed against the direction of travel, comprises a pistons in a cylinder that introduces the force into the belt system via a piston rod.

5. The vehicle according to claim 4, wherein the pistons is driven in the cylinder by gas pressure.

6. The vehicle according to claim 5, wherein gas used for generation of the gas pressure of the piston in the cylinder is stored in a tank.

7. The vehicle according to claim 6, wherein the gas pressure of the gas used to drive the piston in the cylinder is generated only upon detection of the decelerating operation of the moving vehicle exceeding the minimum deceleration value through an ignition device.

8. The vehicle according to claim 1, further comprising a belt tightening system, that removes the existing belt slack on initiation of the decelerating operation exceeding the minimum deceleration value.

9. The vehicle according to claim 6, further comprising a porous heat-absorbing mass located in the tank.

10. The vehicle according to claim 6, further comprising a vent opening is provided in the tank, the vent opening being closed via a tappet by a closure body.

11. The vehicle according to claim 10, wherein the tappet is supported on an intermediate housing and that the tappet loses its support upon movement of the intermediate housing in a direction.

12. The vehicle according to claim 10, wherein operating pressure of the gas in the tank is determined by a force of a spring acting on the closure body of the vent opening.

13. The vehicle according to claim 6, further comprising a control valve provided by means of which gas mass flow from the tank to a cylinder chamber in the cylinder can be influenced.

14. The vehicle according to claim 4, wherein the piston rod used to transmit force from the piston to the belt system is secured with a blocking pin.

15. The vehicle claim 4, further comprising a locking element for holding a breechblock piston arranged on the piston rod, the locking element giving the breechblock piston free movability upon a movement of the piston rod.

16. The vehicle according to claim 15, wherein the locking element for holding the breechblock piston is unlocked with a control cable through the rotary motion of a belt retractor.

17. The vehicle according to claim 15, wherein the locking element for holding the breechblock piston is unlocked with gas pressure of a pyrotechnical propellant charge of a belt tightener.

18. The vehicle according to claim 16, wherein the control cable is drawn by a centrifugal clutch on a belt coiling shaft of the belt retractor.

19. The vehicle according to claim 6, further comprising a breechblock piston fixed with a locking element is positioned in a connecting pipe between the tank and a cylinder chamber, the piston closes the tank against pressure loss of compressed gas.

20. The vehicle according to claim 19, wherein the connecting pipe has a collection chamber to receive the breechblock piston.

21. The vehicle according to claim 20, further comprising an opening sealed by the breechblock piston in the connecting pipe to lead through the locking element for fixing the breechblock piston with the position of the breechblock piston in the collection chamber.

22. The vehicle according to claim 4, further comprising deflectors and with the aid of the deflectors a belt webbing of the belt system is guided through a deflector attached to the piston rod such that the force produced by tightening the belt webbing draws the piston rod out of the cylinder via a path.

23. The vehicle according to claim 6, wherein the tank is closed with a sealing membrane.

24. The vehicle according to claim 23, wherein the sealing membrane is destroyed by a projectile driven by gas of an electrically ignited pressure cylinder.

25. The vehicle according claim 23, wherein the sealing membrane breaks when an operating pressure of the gas in the tank is reached.

26. The vehicle according to claim 6, wherein the tank is filled with a lower pressure of the gas than is necessary for the functioning thereof.

27. The vehicle according to claim 6, wherein an operating pressure of the gas for supplying a quantity of gas produced by combustion of pyrotechnical solids is generated.

28. The vehicle according to claim 27, wherein the pyrotechnical solids is ignited by an electric igniter.

29. The vehicle according to claim 4, further comprising an extension on a back of the piston extending into a clamping jaw system formed by clamping jaws, a spring, the intermediate housing, and a housing.

30. The vehicle according to claim 29, further comprising an extension that does not have a form closure with the inner clamping jaws over a movement area.

31. The vehicle according to claim 30, wherein the extension has a form closure with the inner clamping jaws outside a movement area.

32. The vehicle according to claim 30, wherein a force closure is made with the clamping jaws with the movement of the extension in a direction outside the movement area over the form closure of the extension over the inner clamping jaws.

33. The vehicle according to claim 30, further comprising with the movement of the extension in a direction, the intermediate housing connected to outer clamping jaws is moved in the direction.

34. The vehicle according to claim 10, wherein with the movement of the intermediate housing in the a first direction, the tappet loses its support.

35. The vehicle according to claim 10, wherein the closure body closing the vent opening located on the pressure tank releases the gas pressure of the gas up to a gas pressure determined by the spring.

36. The vehicle according to claim 1, wherein an entire system of claim 1 is assigned to the belt retractor.

37. The vehicle according to claim 1, wherein an entire system of claim 1 is assigned to the belt buckles.

38. The vehicle according to claim 1, further comprising a rotating fitting of a seat back of the seat which rotates freely after the locking lever has been removed.

39. The vehicle according to claim 38, wherein the free rotary movement of the rotating fitting is limited by a stop.

40. The vehicle according to claim 38, wherein the locking lever is moved by a magnet activated by electric current into a position to release the rotary movement of the rotating fitting of the seat back.

41. The vehicle according to claim 4, further comprising a rotating fitting of a seat back of the seat which rotates freely after a locking lever has been removed.

42. The vehicle according to claim 41, wherein the free rotary movement of the rotating fitting is limited by a stop.

43. The vehicle according to claim 42, wherein the locking lever is moved by a magnet activated by electric current into a position to release the rotary movement of the rotating fitting of the seat back.

44. The vehicle according to claim 4, further comprising a seal assigned to the piston rod, the seal seals the cylinder from a gas leak, and a deformation element movable by gas pressure is assigned to the seal, the deformation element deforms the seal in a direction of the piston rod if a predetermined gas pressure in the cylinder is exceeded.

45. The vehicle according to claim 44, wherein the seal is supported in a groove in the deformation element, which groove is open in the direction of the piston rod and a cylinder end surface.

46. The vehicle according to claim 45, wherein the groove is narrower in an axial direction of the piston rod than the seal in a non-deformed condition.

47. The vehicle according to claim 45, wherein the groove has an oblique mating surface at an acute angle to the piston rod.

48. The vehicle according to claim 44, wherein the deformation element is spring-loaded against the gas pressure.

49. The vehicle according to claim 4, further comprising a passage with a closure (80) that is supported in the piston in a displaceable manner is provided in the piston, the passage has a projection that strikes against a stop when a predetermined traversing position has been reached, the passage being displaced relative to the piston and releases the opening.

50. The vehicle according to claim 49, wherein the closure is held in the piston via a seal.

51. The vehicle according to claim 4, further comprising an opening is embodied in the cylinder wall, the opening connects a pressure chamber with the surroundings, and which releases a passage and discharges gas pressure into the surroundings when a predetermined traversing position of the piston has been exceeded.
